(19) United States
(12) Patent Application Publication
(10) Pub. No.: US 2025/0320330 A1
(43) Pub. Date: Oct. 16, 2025

(54) RESIN COMPOSITION

(71) Applicant: NAN YA PLASTICS CORPORATION, Taipei City (TW)

(72) Inventors: Ching-Yao Yuan, Taipei City (TW); Wei-Ru Huang, Taipei City (TW); Hung-Yi Chang, Taipei City (TW); Chia-Lin Liu, Taipei City (TW)

(73) Assignee: NAN YA PLASTICS CORPORATION, Taipei City (TW)

(21) Appl. No.: 18/655,334

(22) Filed: May 6, 2024

(30) Foreign Application Priority Data
Apr. 16, 2024 (TW) 113114132

(51) Int. Cl. C08G 59/68; C08G 59/50; C08J 5/24; C08K 9/04

(52) U.S. Cl. CPC C08G 59/686; C08G 59/5046; C08J 5/244; C08J 5/249; C08K 9/04; C08J 2363/00; C08K 2201/005; C08K 2201/011; C08K 2201/014

(57) ABSTRACT

A resin composition includes a resin, a first filler, a second filler, and a third filler. The resin includes an epoxy resin, a bismaleimide resin, a hardener, or a combination thereof. The first filler has a first particle size. The second filler has a second particle size. The third filler has a third particle size. The first particle size is greater than the second particle size, and the second particle size is greater than the third particle size.

### CROSS-REFERENCE TO RELATED APPLICATION

This application claims the priority benefit of Taiwan application serial no. 113114132, filed on Apr. 16, 2024. The entirety of the above-mentioned patent application is hereby incorporated by reference herein and made a part of this specification.

### BACKGROUND OF THE INVENTION

### Field of the Invention

The invention relates to a resin composition.

### Description of Related Art

With the development of semiconductor techniques, current substrates are gradually unable to meet the needs thereof for heat resistance, glass transition temperature (Tg), and/or coefficient of thermal expansion (CTE). For example, the use of fillers often directly affects the performance and the processability of the resin composition, so the design of fillers is an important issue in technological development.

### SUMMARY OF THE INVENTION

The invention provides a resin composition, wherein a substrate made therefrom has both performance and processability.

A resin composition of the invention includes a resin, a first filler, a second filler, and a third filler. The resin includes an epoxy resin, a bismaleimide resin, a hardener, or a combination thereof. The first filler has a first particle size. The second filler has a second particle size. The third filler has a third particle size. The first particle size is greater than the second particle size, and the second particle size is greater than the third particle size.

In an embodiment of the invention, a range of the first particle size is greater than or equal to 0.5 micrometers and less than or equal to 1 micrometer, a range of the second particle size is greater than or equal to 0.1 micrometers and less than or equal to 0.3 micrometers, and a range of the third particle size is less than 0.1 micrometers.

In an embodiment of the invention, at least two of the first filler, the second filler, and the third filler are the same.

In an embodiment of the invention, the first filler, the second filler, and the third filler are all different.

In an embodiment of the invention, one or a plurality of the first filler, the second filler, and the third filler has an epoxy group or an amine group.

In an embodiment of the invention, the first filler, the second filler, and the third filler are all selected from one or a plurality of silica, boron nitride, aluminum oxide, and aluminum nitride.

In an embodiment of the invention, a weight proportion of the first filler in the resin composition is between 25 wt % and 60 wt %, a weight proportion of the second filler in the resin composition is between 5 wt % and 25 wt %, and a weight proportion of the third filler in the resin composition is between 5 wt % and 25 wt %.

In an embodiment of the invention, a weight proportion of the third filler in the resin composition is greater than a weight proportion of the first filler in the resin composition and a weight proportion of the second filler in the resin composition.

In an embodiment of the invention, a sum of weight proportions of the first filler, the second filler, and the third filler in the resin composition is greater than a weight proportion of the resin in the resin composition.

In an embodiment of the invention, a weight proportion of the epoxy resin in the resin is between 1 wt % and 10 wt %, a weight proportion of the bismaleimide resin in the resin is between 10 wt % and 20 wt %, and a weight proportion of the hardener in the resin is between 3 wt % and 10 wt %.

Based on the above, in the invention, by matching fillers with three different particle size ranges, the void ratio in the resin composition may be effectively reduced, a better stacking state may be achieved, the heat resistance, the glass transition temperature, and the coefficient of thermal expansion of the substrate made therefrom may be improved, while maintaining better adhesion and fluidity. In this way, both performance and processability may be achieved.

In order to make the aforementioned features and advantages of the disclosure more comprehensible, embodiments accompanied with figures are described in detail below.

### DESCRIPTION OF THE EMBODIMENTS

In the following detailed description, for purposes of illustration and not limitation, exemplary embodiments disclosing specific details are set forth in order to provide a thorough understanding of the various principles of the invention. It will be apparent, however, to one of ordinary skill in the art, having the benefit of this disclosure, that the invention may be practiced in other embodiments that depart from the specific details disclosed herein.

Unless otherwise stated, the term “between” used in this specification to define numerical ranges is intended to cover ranges equal to and between the stated endpoints. For example, if a size range is between a first value and a second value, it means that the size range may cover the first value, the second value, and any value between the first value and the second value.

Unless otherwise defined, all terms (including technical and scientific terms) used herein have the same meaning as commonly understood by those skilled in the art to which this invention belongs.

In the present embodiment, the resin composition includes a resin, a first filler, a second filler, and a third filler, wherein the resin includes an epoxy resin, a bismaleimide resin, a hardener, or a combination thereof. More specifically, the first filler has a first particle size, the second filler has a second particle size, the third filler has a third particle size, and the first particle size is greater than the second particle size, and the second particle size is greater than the third particle size. That is, the resin composition includes at least three fillers with different particle sizes. Based on the above, in the present embodiment, by matching fillers with three different particle size ranges, the void ratio in the resin composition may be effectively reduced, a better stacking state may be achieved, the heat resistance, the glass transition temperature, and the coefficient of thermal expansion of the substrate made therefrom may be improved, while maintaining better adhesion and fluidity. In this way, both performance and processability may be achieved.

For example, in recent years, semiconductor development has gradually moved toward heterogeneous integration to improve efficiency, wherein the core technique is advanced packaging. In advanced packaging, there are higher requirements for accuracy and reliability, and the substrate made of the resin composition of the present embodiment may more appropriately meet the above requirements, but the invention is not limited thereto.

In some embodiments, the range of the first particle size is greater than or equal to 0.5 micrometers and less than or equal to 1 micrometer (for example, 0.5 micrometers, 0.7 micrometers, 0.9 micrometers, 1 micrometer, or any appropriate value between 0.5 micrometers and 1 micrometer), the range of the second particle size is greater than or equal to 0.1 micrometers and less than or equal to 0.3 micrometers (for example, 0.1 micrometers, 0.15 micrometers, 0.2 micrometers, 0.3 micrometers, or any appropriate value between 0.1 micrometers and 0.3 micrometers), and the range of the third particle size is less than 0.1 micrometers (for example, 0.05 micrometers, 0.04 micrometers, 0.03 micrometers, 0.01 micrometers, or any suitable value less than 0.1 micrometers), but the invention is not limited thereto.

In some embodiments, at least two of the first filler, the second filler, and the third filler are the same, that is, the first filler, the second filler, and the third filler may all be the same, or, the first filler may be the same as the second filler and different from the third filler, or the first filler may be the same as the third filler and different from the second filler, and so on. However, the invention is not limited thereto, and the first filler, the second filler, and the third filler may also all be different.

In some embodiments, when one or a plurality of the first filler, the second filler, and the third filler are inorganic, modification may be further made thereto, such as providing an epoxy group or an amine group thereto to enhance the compatibility thereof with organic matter such as resin, but the invention is not limited thereto. Here, the modification method may be to mix an inorganic substance with a suitable organic resin containing an epoxy group or an amine group, and zirconium bead mill with a diameter of 0.5 millimeters (mm) to 5 mm may be added. However, the invention is not limited thereto, and other suitable modification methods may also be used. The invention is not limited to the modification method.

In some embodiments, the first filler is selected from one or a plurality of silica, boron nitride, aluminum oxide, and aluminum nitride, the second filler is selected from one or a plurality of silica, boron nitride, aluminum oxide, and aluminum nitride, and the third filler is selected from one or a plurality of silica, boron nitride, aluminum oxide, and aluminum nitride, but the invention is not limited thereto. The first filler, the second filler, and the third filler may be selected according to actual design requirements.

In some embodiments, the weight proportion of the first filler in the resin composition is between 25 wt % and 60 wt % (such as 25 wt %, 35 wt %, 50 wt %, 60 wt %, or any appropriate value between 25 wt % and 60 wt %), the weight proportion of the second filler in the resin composition is between 5 wt % and 25 wt % (such as 5 wt %, 10 wt %, 15 wt %, 25 wt %, or any appropriate value between 5 wt % and 25 wt %), the weight proportion of the third filler in the resin composition is between 5 wt % and 25 wt % (such as 5 wt %, 10 wt %, 15 wt %, 25 wt %, or any appropriate value between 5 wt % and 25 wt %), but the invention is not limited thereto.

In some embodiments, the weight proportion of the third filler in the resin composition is greater than the weight proportion of the first filler in the resin composition and the weight proportion of the second filler in the resin composition, so as to have a better void filling effect, but the invention is not limited thereto.

In some embodiments, the resin composition is composed of a resin, a first filler, a second filler, and a third filler. In other words, the sum of the weight proportions of the resin, the first filler, the second filler, and the third filler in the resin composition is 100 wt %, wherein the sum of the weight proportions of the first filler, the second filler, and the third filler in the resin composition may be greater than the weight proportion of the resin in the resin composition, but the invention is not limited thereto.

In some embodiments, the weight proportion of the epoxy resin in the resin is between 1 wt % and 10 wt % (such as 1 wt %, 5 wt %, 7 wt %, 10 wt %, or any appropriate value between 1 wt % and 10 wt %), the weight proportion of the bismaleimide resin in the resin is between 10 wt % and 20 wt % (such as 10 wt %, 12 wt %, 15 wt %, 20 wt %, or any appropriate value between 10 wt % and 20 wt %), the weight proportion of the hardener in the resin is between 3 wt % and 10 wt % (such as 3 wt %, 5 wt %, 7 wt %, 10 wt %, or any appropriate value between 3 wt % and 10 wt %), but the invention is not limited thereto.

In some embodiments, the weight proportion of the bismaleimide resin in the resin is greater than the weight proportion of the epoxy resin in the resin and/or the weight proportion of the bismaleimide resin in the resin is greater than the weight proportion of the hardener in the resin, but the invention is not limited thereto.

In some embodiments, the resin is only composed of the epoxy resin, the bismaleimide resin, and the hardener. In other words, the total weight proportion of the epoxy resin, the bismaleimide resin, and the hardener in the resin is 100 wt %, but the invention is not limited thereto.

In some embodiments, the epoxy resin includes an epoxy resin having a biphenyl structure, a naphthalene structure, or the like.

In some embodiments, the bismaleimide (BMI) resin includes BMI-1000 (CAS NO: 13676-54-5), BMI-2000 (CAS NO: 67784-74-1), BMI-2300 (CAS NO: 67784-74-1), BMI-3000 (CAS NO: 3006-93-7), BMI-4000 (CAS NO: 79922-55-7), BMI-5100 (CAS NO: 105391-33-1), BMI-7000 (CAS NO: 6422-83-9), or the like.

In some embodiments, the hardener includes an acid anhydride such as phenolic novolac resin, cresol novolac resin, bisphenol A novolak resin, benzoxazine resin, biphenyl novolac type phenolic resin, aminotriazine novolac type phenolic resin, pyromellitic anhydride, trimellitic anhydride, benzophenonetetracarboxylic acid.

It should be noted that the resin composition of the invention may be processed into a prepreg and a copper foil substrate (CCL) according to actual design requirements, and the specific implementations listed above are not limitations of the invention. Anything included in the resin composition is within the scope of the invention.

The following examples and comparative examples are given to illustrate the effects of the invention, but the scope of the invention is not limited to the scope of the examples.

The substrate produced in each example and comparative example was evaluated by the following method.

The glass transition temperature (° C.) was tested with a dynamic mechanical analyzer (DMA).

Coefficient of thermal expansion (CTE): the coefficient of thermal expansion of the material was measured at 50° C. to 120° C. (x-y plane direction) via TMA.

Water absorption (%): after heating the sample in a pressure cooker at 120° C. and 2 atm for 120 minutes, the weight change before and after heating was calculated.

Resin flow rate: depression was performed with 200 plus or minus 25 PSI using a press at 170° C. plus or minus 2.8° C. for 10 minutes. After fusion and cooling, a disc was punched out. The weight of the disc was accurately weighed to calculate the outflow of resin.

### Examples 1 to 4, Comparative Examples 1 to 4

The varnish formed by the resin composition shown in Table 1 was impregnated with Nan Ya fiberglass cloth (Nan Ya Plastics Corporation, cloth type 2118S) at room temperature, then dried at 120° C. (impregnation machine) for a few minutes to obtain a prepreg with a resin content of 50 wt %. A constant temperature was maintained for 20 minutes at a pressure of 25 kg/cm² and a temperature of 85° C., then the temperature was increased to 250° C. at a heating rate of 3° C./min, and then the temperature was kept constant for 120 minutes, then cooling was slowly performed to obtain a copper foil substrate, and then the surface copper foil was removed to form a bare board, and various properties were evaluated. Here, it should be noted that the bare board used for testing was further made into the desired substrate via a subsequent processing step. Even though the numerical values of Comparative example 1 and Comparative example 2 had similar physical properties to Examples 1 to 4 on this bare board, since Comparative example 1 and Comparative example 2 had delamination issues (such as poor adhesion), the desired substrate may not be made via subsequent processing, resulting in poor processability.

The physical properties of the produced copper foil substrate were tested, and the results thereof are shown in Table 1. After comparing the results of Examples 1 to 4 and Comparative examples 1 to 3 of Table 1, the following conclusions may be drawn: compared with the substrates produced in Comparative examples 1 to 4, the substrates produced in Examples 1 to 4 may effectively improve the thermal properties of the substrate (such as glass transition temperature, coefficient of thermal expansion) and maintain high fluidity to achieve both performance and processability. In addition, it may be seen from Comparative example 1 and Comparative example 2 that when a single filler with a smaller particle size was used, there was an issue of higher water absorption.

TABLE 1

| | | Example | | | | | | | | Comparative example | | | | | | | |
|---|---|---|---|---|---|---|---|---|---|---|---|---|---|---|---|---|---|
| | | 1 | | 2 | | 3 | | 4 | | 1 | | 2 | | 3 | | 4 | |
| Resin | Epoxy resin | 5 | wt % | 5 | wt % | 5 | wt % | 5 | wt % | 5 | wt % | 5 | wt % | 5 | wt % | 5 | wt % |
| | (Nippon Kayaku | | | | | | | | | | | | | | | | |
| | NC-3500) | | | | | | | | | | | | | | | | |
| | Bismaleimide resin | 20 | wt % | 20 | wt % | 20 | wt % | 20 | wt % | 20 | wt % | 20 | wt % | 20 | wt % | 20 | wt % |
| | (BMI-1000) | | | | | | | | | | | | | | | | |
| | Hardener | 5 | wt % | 5 | wt % | 5 | wt % | 5 | wt % | 5 | wt % | 5 | wt % | 5 | wt % | 5 | wt % |
| | (benzoxazine resin) | | | | | | | | | | | | | | | | |

| First filler (silica, particle | 45 | wt % | 45 | wt % | 45 | wt % | 55 | wt % | 0 | | 0 | | 70 | wt % | 40 | wt % |
|---|---|---|---|---|---|---|---|---|---|---|---|---|---|---|---|---|
| size was 0.8 micrometers, | | | | | | | | | | | | | | | | |
| modified functional group | | | | | | | | | | | | | | | | |
| was epoxy group) | | | | | | | | | | | | | | | | |
| Second filler (silica, | 10 | wt % | 20 | wt % | 15 | wt % | 10 | wt % | 0 | | 70 | wt % | 0 | | 30 | wt % |
| particle size was 0.2 | | | | | | | | | | | | | | | | |
| micrometers, modified | | | | | | | | | | | | | | | | |
| functional group was | | | | | | | | | | | | | | | | |
| epoxy group) | | | | | | | | | | | | | | | | |
| Third filler (silica, particle | 15 | wt % | 5 | wt % | 10 | wt % | 5 | wt % | 70 | wt % | 0 | | 0 | | 0 | |
| size was 0.03 | | | | | | | | | | | | | | | | |
| micrometers, modified | | | | | | | | | | | | | | | | |
| functional group was | | | | | | | | | | | | | | | | |
| amine group) | | | | | | | | | | | | | | | | |
| Glass transition | 330 | | 340 | | 340 | | 345 | | 280 | | 290 | | 350 | | 345 | |
| temperature (° C.) | | | | | | | | | | | | | | | | |
| Coefficient of thermal | 1.6 | | 2.2 | | 1.9 | | 2.5 | | 1.7 | | 2.2 | | 4.0 | | 3.4 | |
| expansion (ppm/° C.) | | | | | | | | | | | | | | | | |

| | | | | | | | | |
|---|---|---|---|---|---|---|---|---|
| Water absorption (%) | 0.4 | 0.4 | 0.4 | 0.4 | 0.5 | 0.5 | 0.3 | 0.3 |
| Resin flow rate (%) | 14 | 17 | 15 | 13 | 15 | 15 | 5 | 10 |

Based on the above, in the invention, by matching fillers with three different particle size ranges, the void ratio in the resin composition may be effectively reduced, a better stacking state may be achieved, the heat resistance, the glass transition temperature, and the coefficient of thermal expansion of the substrate made therefrom may be improved, while maintaining better adhesion and fluidity. In this way, both performance and processability may be achieved.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A resin composition, comprising:
a resin comprising an epoxy resin, a bismaleimide resin, a hardener, or a combination thereof;
a first filler having a first particle size;
a second filler having a second particle size; and
a third filler having a third particle size, wherein the first particle size is greater than the second particle size, and the second particle size is greater than the third particle size.

2. The resin composition of claim 1, wherein a range of the first particle size is greater than or equal to 0.5 micrometers and less than or equal to 1 micrometer, a range of the second particle size is greater than or equal to 0.1 micrometers and less than or equal to 0.3 micrometers, and a range of the third particle size is less than 0.1 micrometers.

3. The resin composition of claim 1, wherein at least two of the first filler, the second filler, and the third filler are the same.

4. The resin composition of claim 1, wherein the first filler, the second filler, and the third filler are all different.

5. The resin composition of claim 1, wherein one or a plurality of the first filler, the second filler, and the third filler has an epoxy group or an amine group.

6. The resin composition of claim 1, wherein the first filler, the second filler, and the third filler are all selected from one or a plurality of silica, boron nitride, aluminum oxide, and aluminum nitride.

7. The resin composition of claim 1, wherein a weight proportion of the first filler in the resin composition is between 25 wt % and 60 wt %, a weight proportion of the second filler in the resin composition is between 5 wt % and 25 wt %, and a weight proportion of the third filler in the resin composition is between 5 wt % and 25 wt %.

8. The resin composition of claim 1, wherein a weight proportion of the third filler in the resin composition is greater than a weight proportion of the first filler in the resin composition and a weight proportion of the second filler in the resin composition.

9. The resin composition of claim 1, wherein a sum of weight proportions of the first filler, the second filler, and the third filler in the resin composition is greater than a weight proportion of the resin in the resin composition.

10. The resin composition of claim 1, wherein a weight proportion of the epoxy resin in the resin is between 1 wt % and 10 wt %, a weight proportion of the bismaleimide resin in the resin is between 10 wt % and 20 wt %, and a weight proportion of the hardener in the resin is between 3 wt % and 10 wt %.
